(19) United States
(12) Patent Application Publication
(10) Pub. No.: US 2007/0205580 A1
(43) Pub. Date: Sep. 6, 2007

(54) Trailer hitch

(75) Inventors: Bruce Hamilton, Hampstead, NH (US); Steven Nardi, Taunton, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Hamilton Marine LLC, Searsport, ME (US)

(21) Appl. No.: 11/365,015

(22) Filed: Mar. 1, 2006

(51) Int. Cl. B60D 1/36

(52) U.S. Cl. 280/477

(57) ABSTRACT

A system, method, and device for hitching a trailer to a vehicle are disclosed. The exemplary system may have a receiving plate with a distal end formed with or coupled to the socket portion. The receiving plate may extend to a proximal end from the socket at an incline. The proximal end may be wider than the distal end. Two support members may extend substantially beyond a socket portion. Two side plates may extend at a downward angle from each side edge of the receiving plate between the proximal end and proximal end. The two side plates may extend downwards to interfere with sharp angled turning.

### TECHNICAL FIELD

The present invention relates to a trailer hitch assembly and more particularly, relates to a self-guiding trailer hitch.

### BACKGROUND INFORMATION

Trailers pulled by a vehicle are often coupled via a ball and socket type hitch. The vehicle has a ball portion that extends vertically from the frame of the hitch. The frame of the hitch may be coupled to the frame or other structural point on the vehicle. The ball portion is designed to receive a socket that fits over the top of the ball portion. The ball portion may range in size from about 1 to 3 inches in diameter. The socket portion is coupled to the frame or structural point on the trailer and faces in a downward direction. The socket portion fits over the ball portion when the trailer is coupled to the vehicle. The socket typically has a latching device that narrows the throat of the socket and prevents the socket from lifting off of the ball portion during use of the hitch. Additional chains may be used to prevent accidental release of the trailer.

During the hitching process, the user raises the socket portion of the hitch to a height above the ball portion on the vehicle. This may be accomplished by cranking a lifting device that raises the hitch portion of the trailer. The user then positions the vehicle and attempts to align the ball portion directly underneath the socket portion. The lifting device is then lowered to allow the socket portion to fit over the ball portion and couple the trailer to the vehicle.

Aligning the ball portion underneath the socket portion often requires skill and/or multiple attempts to properly align the ball portion underneath the socket. Damage to the vehicle and trailer may result if the user backs the vehicle up too far and drives the vehicle into the hitch portion, or into a portion of the trailer. If the user does not back the vehicle far enough or the vehicle is not centered, the user must reposition the vehicle. If the trailer is located in sand or soft or uneven ground, the wheel at the base of the supporting front trailer jack, if so equipped, will not allow for traverse adjustment of the trailer, requiring exact alignment of the towing vehicle ball with the trailer socket. Lack of an assistant to guide the user, inclement weather, and lack of lighting may further complicate the hitching process.

Some devices have attempted to address these problems by providing a guiding mechanism for the hitching process. However, these devices are limited in the scope of their usefulness. Some require removal after the hitching process or a specially designed ball portion to prevent the guiding mechanism or trailer from hitting the vehicle during the towing process. The guiding mechanisms may not handle the full tongue weight of the trailer. Current alignment systems rely on the ability of the trailer to roll from side to side for traverse alignment. They do not account for a trailer jack without a wheel or a trailer jack that is positioned in sand, soft or uneven ground, rendering them ineffective in these conditions. Other systems are not designed to elevate the front of the trailer off of the ground at its support point for full, unencumbered side to side traverse alignment as the towing vehicle is backing. Current systems may cause excessive wear of the hitch ball and guiding mechanism over time due to metal-to-metal contact friction with repeated coupling. Current guiding mechanisms also do not alert the user when the socket portion is about to receive the ball. Accordingly, a need exists for a device, method, and system that allows a user to efficiently couple a ball and socket hitch in diverse ground and weather conditions, without causing excessive wear to the hitch ball or alignment system, without causing potential damage to the tow vehicle or trailer, and with the benefit of a feedback system that alerts the vehicle operator when the ball is in close proximity with the hitch socket.

### SUMMARY

The present invention is a novel device, system, and method for a self-guiding trailer hitch. An exemplary embodiment, according to the present invention, provides a trailer hitch having two support members, a receiver plate, and two side plates. The described embodiment of the alignment system is a system designed as an add-on feature to an existing, standard trailer hitch by means of two support members having a “U” shaped profile with the opening of the “U” facing inward to capture the hitch flange or a portion of the trailer frame. The two support members may each have multiple fasteners located along the length of the support member coupling the support member to the trailer hitch flange or trailer frame. The two support members may extend substantially beyond a socket portion. A receiver plate may have a distal end coupled to the socket portion. The receiver plate may extend to a proximal end from the socket at an incline wherein the proximal end is wider than the distal end portion. The two side plates may extend at a downward angle from each side edge of the receiver plate between the proximal end and distal end with the bottom edge of the plates substantially parallel to the angle of the receiving plate. In this embodiment, the side plates are angled so as not to interfere with any portion of the tow vehicle or hitch ball support when the tow vehicle is making a sharp turn.

Alternate embodiments may include one or more of the following. The two side plates may extend at a downward angle from each side edge of the receiver plate between the proximal end and distal end with the bottom edge of the plates being substantially parallel with the ground. In this embodiment, the side plates are designed to interfere and make contact with the hitch ball support member when the tow vehicle is making a sharp turn. This calculated interference is designed to prevent a common problem commonly known as “jack-knifing” of the trailer. The proximal end of the receiver plate may have a rounded profile. The receiver plate may have an offset lip extending parallel with the downward angle of the receiver plate that creates a pocket for the front flange of the hitch socket. The receiver plate ball contact surface and the inner surfaces of the two side plates may have an applied coating to obtain wear resistance and to lower the coefficient of friction. Similarly, the hitch ball socket may have a friction reducing coating applied to its inner surface. Alternately, the receiver plate may have a wear plate coupled its ball contact surface area to protect the hitch ball and the receiver plate from excessive wear or damage and to lower the coefficient of friction between the hitch ball and the receiving plate. The wear plate may have an offset lip extending parallel with the downward angle of the receiver plate that creates a pocket for the front flange of the hitch socket. The receiver plate may be formed with a proximity indicator which may consist of a thin bump or series of bumps or valleys formed into the ball contact surface of the receiver plate, offset proximally a small distance from the front radius of the hitch socket. Alternately, if a wear plate is used, the wear plate may be formed with a proximity indicator, which may consist of a thin bump or series of bumps or valleys formed onto the ball contact surface of the wear plate, offset proximally a small distance from the front radius of the hitch socket. An exemplary embodiment, according to the present invention, provides a trailer hitch metal body that is a one piece construction. The one piece construction trailer hitch unit, usually a stamped or cast metal body, includes the trailer frame tongue attachment portion, the ball socket portion and the angled receiver plate with two side plates. The one piece embodiment may include all of the features of the above add-on embodiment. Additionally, in this embodiment, the ball socket circumference may be manufactured at a downward sloping angle, in the proximal to distal direction. In this embodiment the highest point of the socket lip is the proximal or leading edge of the socket and the lowest point on the lip is the distal or trailing edge of the socket. In other words, the front lip of the socket is higher than all other edges of the socket portion. The socket portion may have a self-latching device.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the claims stated later herein.

### BRIEF DESCRIPTION OF THE DRAWINGS

These and other features and advantages of the present invention will be better understood by reading the following detailed description, taken together with the drawings wherein:

FIGS. 1A, 1B, 1C, and 1D are sequential side views of the trailer and hitch as the ball portion makes contact with the receiver assembly according to an exemplary embodiment of the invention.

FIGS. 2A, 2B, and 2C are top views of the ball portion allowable positions for making contact with the receiver assembly at different alignment paths according to an exemplary embodiment of the invention.

FIG. 3A is a perspective view of the receiver assembly portion according to a first exemplary embodiment of the invention.

FIG. 3B is a side view of the receiver assembly according to the first exemplary embodiment of the invention.

FIG. 3C is a side view of a variation of the receiver assembly according to the first exemplary embodiment of the invention.

FIG. 3D is a bottom view of the receiver assembly according to the first exemplary embodiment of the invention.

FIG. 3E is a side view of the receiver assembly coupled to a ball portion according to the first exemplary embodiment of the invention.

FIG. 4A is a side view of the receiver assembly portion according to the second exemplary embodiment of the invention.

FIG. 4B is a side view of the receiver assembly portion according to the second exemplary embodiment of the invention.

FIG. 4C is a perspective view of the receiver assembly portion according to the second exemplary embodiment of the invention.

FIG. 4D is a top view of the receiver assembly portion according to the second exemplary embodiment of the invention.

FIG. 4E is a side view of the receiver assembly coupled to a ball portion according to the second exemplary embodiment of the invention.

FIG. 5 is a side view of the receiver assembly coupled to a ball portion according to a variation of the second exemplary embodiment of the invention.

FIG. 6A is top view of the receiver assembly portion according to a third exemplary embodiment of the invention.

FIG. 6B is a side view of the receiver assembly portion according to the third exemplary embodiment of the invention.

FIG. 7A is a side view of the receiver assembly portion according to the third exemplary embodiment of the invention.

FIG. 7B is a top view of the receiver assembly portion according to the third exemplary embodiment of the invention.

FIG. 8A is a side view of the ball portion according to a first exemplary embodiment ball portion of the invention.

FIG. 8B is a perspective view of the ball portion according to the first exemplary embodiment ball portion of the invention.

FIG. 8C is a cross sectional view of the ball portion uncompressed according to the first exemplary embodiment ball portion of the invention.

FIG. 8D is a cross sectional view of the ball portion compressed according to the first exemplary embodiment ball portion of the invention.

### DETAILED DESCRIPTION

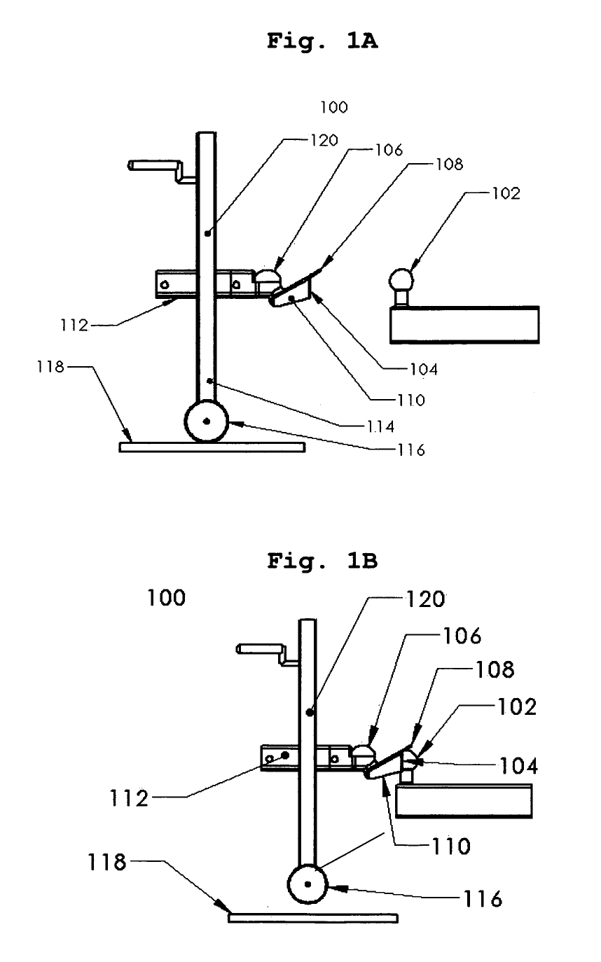

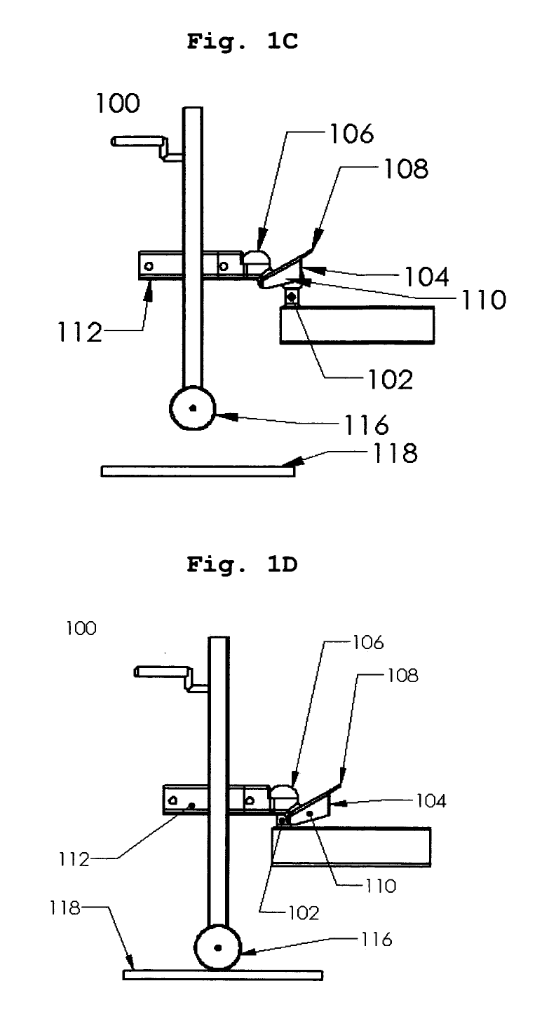

Referring to FIGS. 1A, 1B, 1C and 1D, a ball portion 102 of a hitch assembly 100 makes contact with a guide assembly 104 according to an exemplary embodiment of the invention. The guide assembly 104 may be coupled to a socket portion 106 of a trailer and allows the ball 102 of a hitch assembly 100 to guide the socket 106 of the hitch assembly 100 onto the ball 102. The guide assembly 100 may have a receiver plate 108, two side plates 110, and two support arms 112. The receiver plate 108 receives the top portion of the ball 102, which is pushed against the receiving plate 108. The receiver plate 108 is driven up and over the ball 102 as the vehicle backs up. The guide assembly 104 lifts the socket 106 of the trailer allowing the ball 102 to slide underneath the socket 106 and also elevates the front wheel or front support point of the trailer 116 above ground level 118 for unencumbered traverse alignment. The details regarding the hitch process of the guide assembly 108 are described in greater detail later herein.

The receiving plate 108 is angled at an incline from the support members 112 and socket 106. The rear edge of the receiving plate 108 is located at the height of the bottom opening of the socket 106. The front or proximal edge is located higher than the rear or distal edge providing a reverse incline plane. This allows the top of the ball 102 to be higher than the bottom opening of the socket 106. Depending on the angle of the incline the top of the ball 102 may be within a range of heights. This allows the user a degree of tolerance for the height of the socket 106 during the hitching process. This will allow a vehicle or trailer located on an uneven or non-level surface the ability to hitch without the socket 106 height being accurately adjusted. A marking system, 114 such as a shrink wrap band or other marking system on the trailer jack 120, to allow the user to jack up the trailer to a repeatable, consistent height may be used with this system.

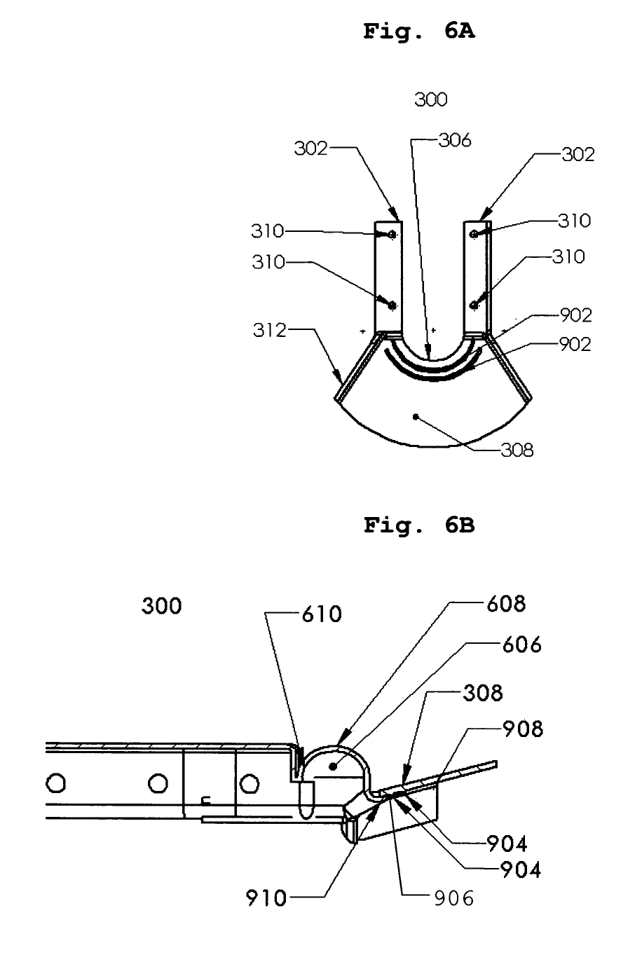

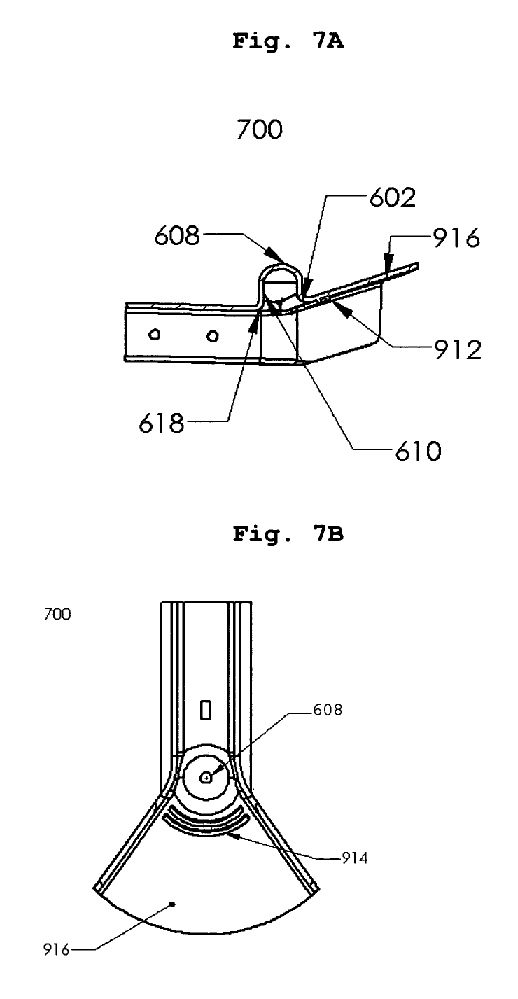

As the tow vehicle backs up, moving the ball 102 in a relatively horizontal direction, referring to FIG. 1A. the receiving plate 108 receives the top portion of the ball 102 which is pushed against the receiving plate 108, referring to FIG. 1B. As the ball 102 continues to move in a relatively horizontal direction, the reverse incline plane provided by the receiving plate 108 drives the guide assembly 104 and socket 106 in a vertical direction up and over the ball 102, referring to FIG. 1C. As the vehicle backs up, moving the ball 102 against the reverse incline plane of the receiver plate 108, the plate also elevates the front wheel or support point of the trailer 116 above ground level 118 for unencumbered, traverse alignment. The hitch socket 106 will drop down over the hitch ball 102 when properly aligned. This invention allows for “one-step” vertical lifting with simultaneous traverse adjustment while the front of the trailer is elevated above the ground surface. This side to side traverse adjustment could not ordinarily be accomplished in deep sand, uneven or soft ground without the benefit of a receiver plate designed to support and lift the tongue weight of the trailer as described herein. The guide assembly 104 may also have a lip portion according to FIGS. 6A, 6B, 7A, and 7B as will be describe later herein.

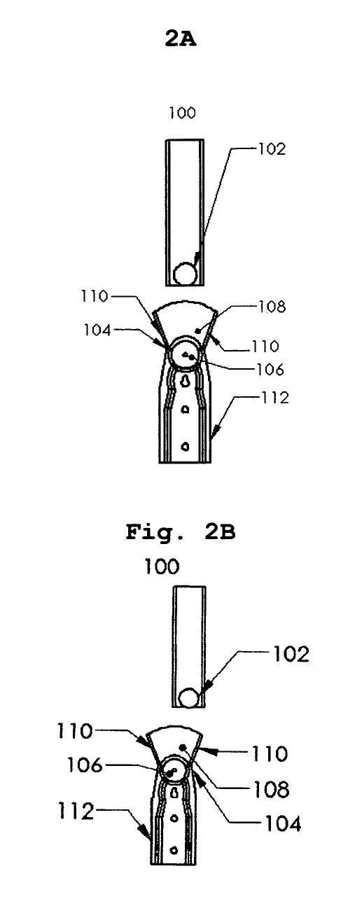

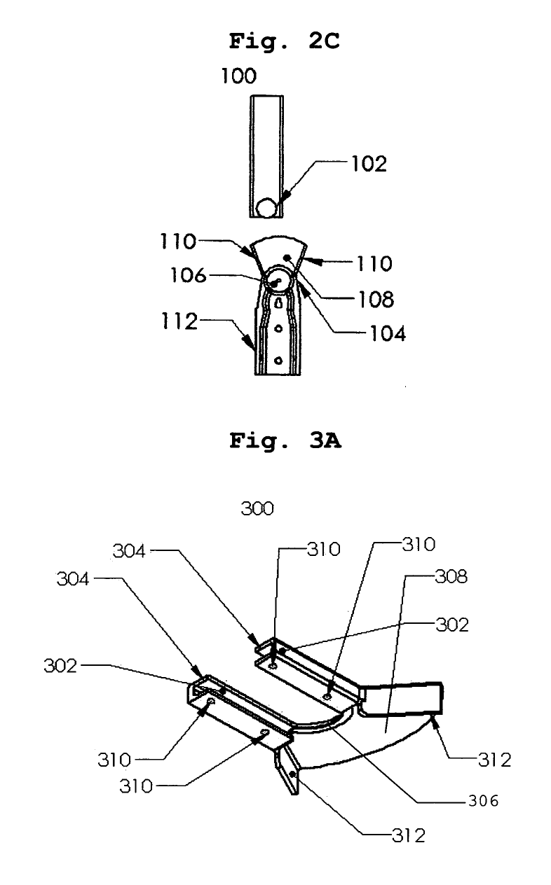

Referring to FIGS. 2A, 2B, and 2C, the two side plates 110 may be used to move the socket 106 of a hitch assembly 100 in a traverse direction. The ball 102 makes contact with a guide assembly 104 according to an exemplary embodiment of the invention. The side plates 110 of the guide assembly 104 receive the ball 102. The side plates 110 are angled from the socket 106 opening. The rear edges of the side plate 110 are located on respective sides of the bottom opening of the socket 106. The front edges of the side plates 110 are located further from the center than the rear edge. This allows the ball 102 to not be centered under the bottom opening of the socket 106 referring to FIG. 2B and FIG. 2C. Depending on the angle of the side plates 110 the ball 102 may be within a range of transverse locations. This allows the user a degree of tolerance for the location of the socket 106 during the hitching process. The vehicle backs up, moving the ball 102 in a relatively horizontal direction, referring to FIGS. 1A, 1B, 1C and 1D. The side plates 110 receive the ball 102, referring to FIG. 1C. As the ball 102 continues to move in a relatively horizontal direction, the side plates 110 guide assembly 104 and socket 106 in a transverse direction centering the socket 106 over the ball 102, referring to FIGS. 2A and 2B and 2C. Gravity pulls the socket 106 down over the ball 102 and the socket 106 is hitched to the ball 102 without the need for the socket 106 to be exactly aligned with the ball 102 in a transverse direction. The detailed motions are as follows: the vehicle backs up, moving the ball 102 in a relatively horizontal direction, referring to FIGS. 1A, 1B, 1C and 1D, causing the hitch ball to be pushed against the receiving plate. The reverse inclined plane of the receiving plate 108 elevates the front of the trailer off of ground level 118 at its support point 116 for full, unencumbered traverse alignment. The support point of the trailer 116 continues to rise in elevation above ground level 118 as the towing vehicle continues backing. The side plates provide a channel for traverse alignment. When the hitch ball 102 reaches the hitch socket 106, the trailer will drop back down in elevation stopping its descent when the hitch ball 102 is fully seated in the hitch socket 106. The reverse incline plane of receiver plate 108 of the hitch assembly 104 together with the side plates 110 allow for simultaneous vertical lifting and transverse alignment.

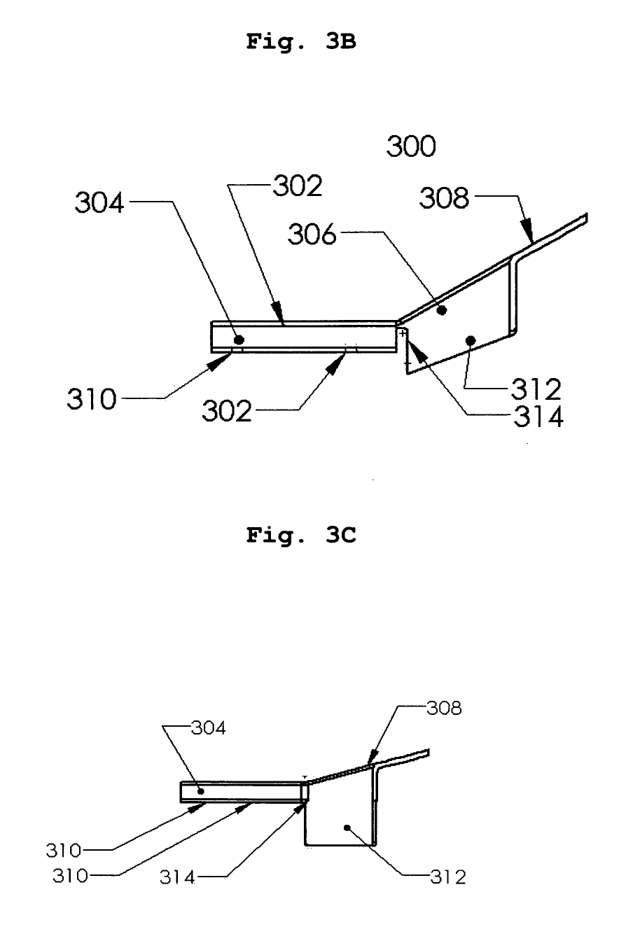

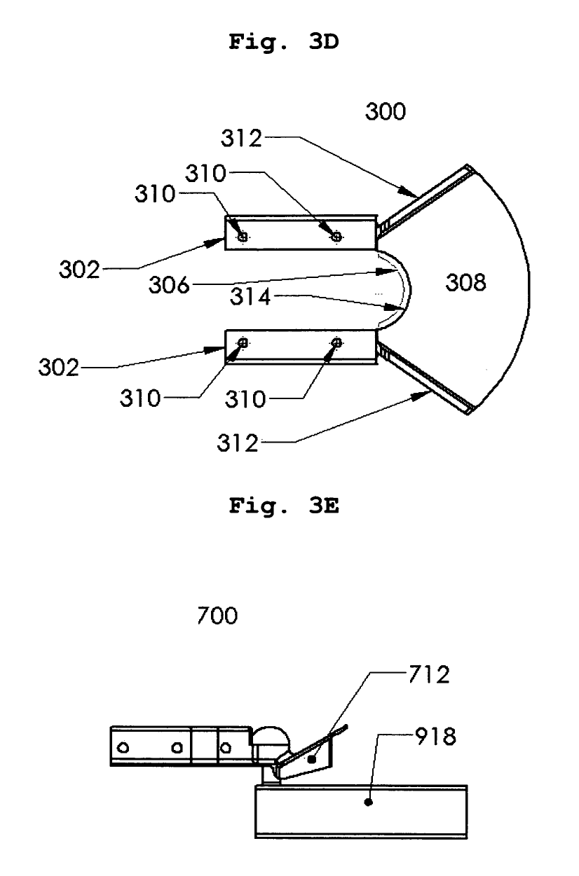

Referring to FIGS. 3A, 3B, 3C, and 3D, the guide assembly 300 according to a first exemplary embodiment of the invention detachably couples to the socket (not shown). The guide assembly 300 may have two support members 302 for coupling to the hitch flange, trailer frame or other structural point on the trailer. The support members extend horizontally along the frame parallel to each other. The horizontal extension allows the support members 302 to provide leverage and transfer the weight to the frame of the trailer.

The support members 302 may have a sideways “U” shaped channel 304 for receiving the flange of the hitch assembly. The support member 302 slides onto the hitch flange with the two “U” shaped channels 304 receiving the flange or a portion of the flange between them the “U” Channels may be of a wide design to slide over portions of the trailer frame. The weight is transferred to the frame via both top and bottom portions of the “U” shaped channels 304. The socket portion of the trailer slides between the two support members 302, allowing the support members 302 to contact the frame portion of the trailer beyond the socket portion.

The “U” shaped channels 304 may utilize a fractional fit. The guide assembly 300 may slide on the front portion of the trailer frame around the socket portion. A rear edge 306 of a receiving plate 308 or a rear flange pocket may prevent the guide assembly 300 from jamming onto the socket portion and frame of the trailer. Other parts or stops may also be used to support the guide assembly 300 in a horizontal direction, for example, but not limited to, the side plates 312 or an additional stop plate. This embodiment may allow the user to quickly slide the guide assembly 300 onto the socket portion and remove the guide assembly 300 after the hitching process is complete if desired

The “U” shaped channels 304 may also be coupled to the frame or socket portion with fasteners 310. The fasteners 310 may include, for example, but not limited to bolts, screws, rivets, welds, or adhesives. The fasteners 310 may permanently couple the guide assembly 300 to the trailer or, for example, may utilize bolts with wing nuts to allow the user the ability to remove the guide assembly 300 as needed. Referring to FIG. 3A and 3B, the receiver portion 308 may have a lip portion 314. The lip portion 314 may be located between the receiving plate 308 and the opening of the socket. The lip portion 314 provides a recess for the front flange of the trailer hitch assembly in the first embodiment. The side plates 312 may extend down and run parallel with the receiver plate 308 to prevent any interference during towing as shown in FIG. 3B. This allows the side plates 312 to ride above the towing portion as shown in FIG. 3E. The side plates 312 may also extend downward and specifically be designed to interfere during towing, as will be discussed in greater detail later herein.

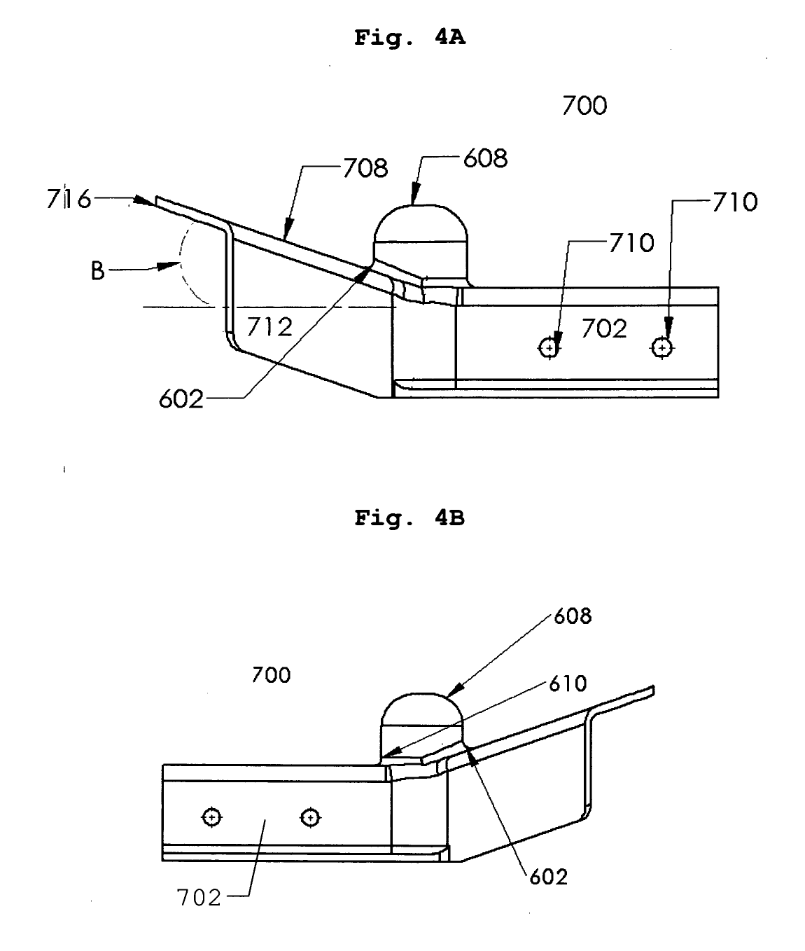

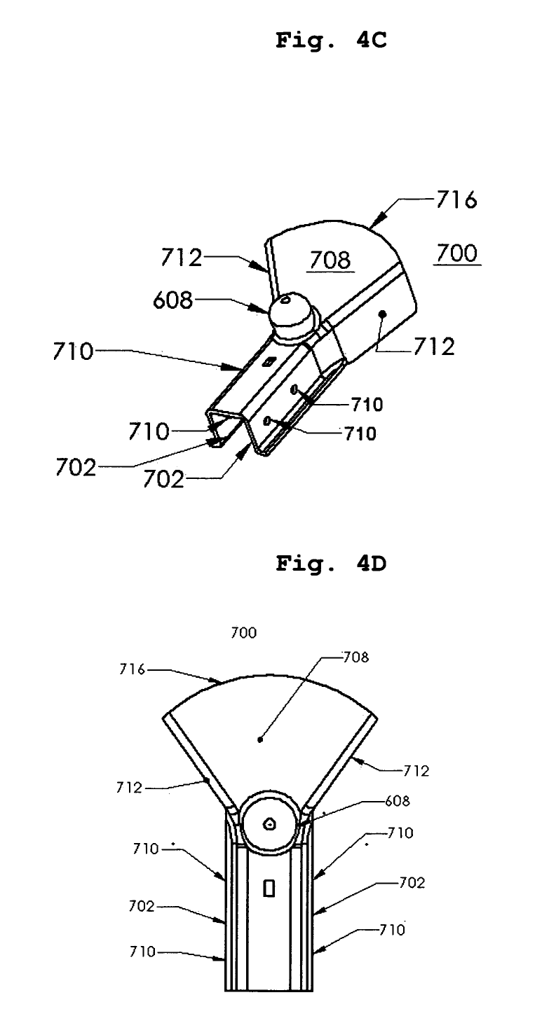

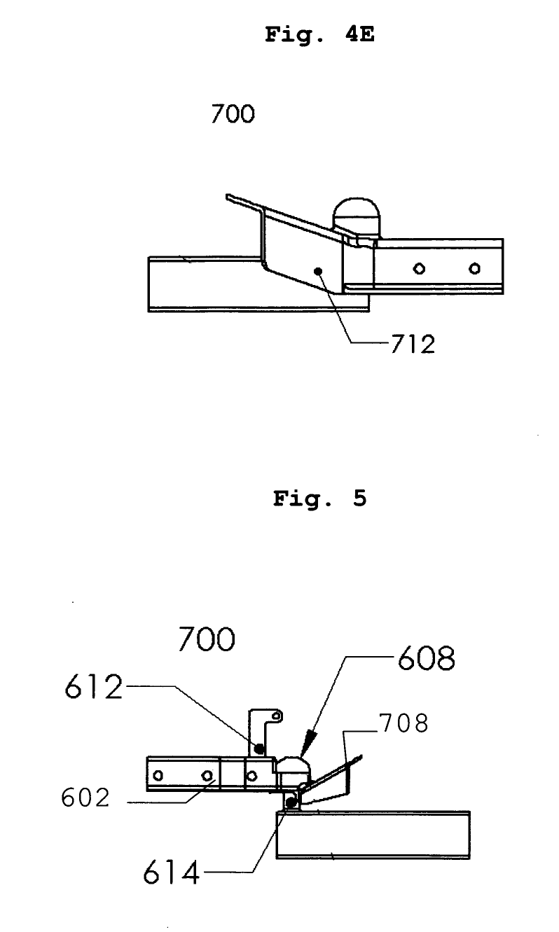

Referring to FIGS. 4A, 4B, 4C, 4D, and 4E, the guide assembly 700 according to a second exemplary embodiment of the invention is coupled to the socket. The guide assembly 700 may have two support members 702 for coupling to the frame or other structural point on the trailer. The support members 702 extend horizontally along the frame parallel to each other and may be coupled to each other on the top or bottom. The horizontal extension allows the support members 702 to provide leverage and transfer the weight to the frame of the trailer. The support members 702 may also incorporate fasteners 710, as previously described, with regard to the first exemplary embodiment. The receiving plate 708 may have a rounded front edge 716. The rounded front edge 716 allows the guide assembly 700 to remain on during towing. As the vehicle turns, the round profile may allow the guide assembly 700 maximum extension while preventing the corners of the receiving plate 708 from hitting when the vehicle is towing the trailer and turns.

The incline angle β (shown in FIG. 4A) of the receiving plate 708 to the plane of the socket opening may range from about 0 to 80 degrees. The incline angle p may be selected based on several factors, for example, intended tongue weight, length of the receiving plate 708, and strength of the guide assembly 700. The side plates 712 may also be angled from the receiving plate 708. The side plates 712 may be substantially parallel to the incline angle B as in second exemplary embodiment shown in 4A and 4B or may be substantially parallel to level ground as in a variation of the first exemplary embodiment shown in 3C. The side plate angles may range from an angle of about 0 (horizontal) to 80 degrees.

The bottom angle of the side plates 312, 712 disclosed above may be designed to either clear the ball hitch support member when the tow vehicle is making a sharp turn or if the side plates 312, 712 are substantially horizontal to the ground, may be designed to interfere with the ball hitch support member when the tow vehicle is making a sharp turn. A problem often encountered with a coupled trailer is commonly known as “jack-knifing”. Jack-knifing often occurs as a result of sudden braking of the tow vehicle. The forward momentum of the trailer being towed causes it to swing sideways ending up substantially perpendicular to the tow vehicle. At this point, the trailer slides sideways causing the trailer tires to skid instead of rolling. Jack-knifing also occurs when a backing tow vehicle turns too sharply and the trailer rolls to an angle substantially perpendicular to the direction of the tow vehicle. At this point, the trailer gets pushed sideways and the trailer tires skid instead of rolling. This may be an undesirable situation that can lead to extensive damage to the tow vehicle and the trailer. An embodiment of this invention addresses this problem. The side plates 312, 712 in the embodiments with side plates extending substantially horizontal or parallel to level ground will act as a “stop” against the ball hitch support when the tow vehicle turns sharply. The side plates 312, 712 interference will prevent “jack-knifing” of the trailer.

Referring to FIG. 5, the receiver portion 612 may have a lip portion 614. The lip portion 614 may be located at the distal edge of the receiving plate 708. The lip portion 614 provides a recess for the front flange of the trailer hitch assembly 602. The socket 608 may have either a manual latching device or a self-latching device. The latching devices narrow a throat portion of the socket 608, preventing the ball from being removed from the socket 608 during towing. The manual latching device requires the user to move a lever that narrows the throat and may be locked into a closed position. The self-latching device may have a lever within the socket 608 that is activated when the ball hits the top portion of the socket 608. Therefore, when the ball fits within the socket 608 the self-latching device is activated and the ball is secured within the socket 608. The user may also couple the trailer with additional towing chains for safety purposes. The user may also couple direction control signal and brake wiring harnesses between the vehicle and trailer. The trailer may be towed to the intended location. The trailer may then be unhitched in a conventional manner. The self-latching device may be released by moving a control lever 612 that releases the latching device and opens the socket 608 throat.

According to the third embodiment of this invention, the lip portion 314, referring to FIGS. 3A-D, may provide a pocket for the front flange of the hitch socket. This pocket feature may be on the ball contact surface of the receiver plate 308 as in FIG. 3D or may be a feature cut into the wear plate 908 as in FIG. 6B. The pocket allows an area for the hitch flange 910 to slip into for a smooth transition of the ball into the socket without hitting or catching on the bump that would be otherwise be encountered by the leading edge of the socket flange 910. This feature may prevent excessive resistance to the coupling process or wear or damage to the hitch flange. Referring to FIG. 6B, this pocket feature 906 may also be formed or cut into the wear plate 908 to create a smooth transition as the hitch ball travels towards and into the hitch socket 608 without hitting or catching on a bump that would otherwise be created by the leading edge of the hitch flange 910.

According to FIG. 6A, FIG. 6B, FIG. 7A and FIG. 7B the receiver plate 308 916 may be formed with a proximity indicator 902, 904, 912, and 914; which may consist of a thin bump or valley, or a series of bumps or valleys formed onto the ball contact surface of the receiving plate. These series of bumps or valleys will be located along a radius in close proximity to the leading edge of the hitch socket. As the tow vehicle backs and the hitch ball travels towards the hitch socket, the ball will encounter the bumps or valleys. At the point of contact and subsequent travel of the ball over this rough portion, a mechanical vibration or jolting sensation is felt by the vehicle operator. Additionally, ball contact with the proximity indicator will create an audible signal, further alerting the driver of the proximity of the hitch ball 102 to the hitch socket 106 opening, referring to FIG. 1A, 1B, 1C and 1D. This signaling allows the driver to slow down at the precise moment for gentle ball to socket engagement. Gravity pulls the socket 106 down over the ball 102, referring to FIG. 1D. As shown in FIGS. 6A, 6B, 7A, and 7B, the proximity indicator 902, 904, 912, and 914 is offset proximally a small distance from the front radius of the hitch socket.

In the first, second, and third embodiments, the hitch ball contact surface areas, including the bottom surface of the receiver plate, the inside surface of the side plates and the inside of the hitch socket itself may have an applied, friction reducing coating. This applied coating will greatly facilitate the coupling process and will prevent premature wear or damage to the receiver socket, the receiver plate and side plates and the hitch ball. Coating the inside of the hitch socket will allow the socket to quickly and easily slide over the hitch ball for positive engagement. A replaceable, friction reducing, wear plate 908, as shown in FIG. 6B, may also be used in place of an applied coating on the bottom surface of the receiver plate 308 and/or the inside plates of the side plates.

In all of the embodiments described herein, the bottom of the receiving plate or the bottom of an added wear plate may contain a feature that consists of a bump or groove, or a series of bumps and grooves just proximal to, and in close proximity to the leading edge of the hitch socket 602 according to FIG. 4A.

Referring to FIG. 6A, this feature 902 is shown on the bottom of the receiving plate (308). According to the third embodiment of this device, referring to FIG. 6B, this feature (904), is shown on the bottom of the wear plate 908. According to the third embodiment of this device, referring to FIG. 7A, this feature 912 is shown on the bottom of the receiving plate (916). Referring to FIG. 7B, this feature 914 is shown on the bottom of the receiver plate 916. According to the third embodiment of this device and referring to FIGS. 1A, 1B, 1C, and 1D, as the receiving plate 108 rides up and over the ball 102, the ball rubs against the bump(s) or groove(s), (not shown), collectively referred to as the “proximity indicator”, and slightly jars the vehicle and signals to the user driving the vehicle that the ball is about to enter the socket 608. This allows the user to slow the vehicle down and prevent overshooting the socket opening. The proximity indicator, according to the descriptions herein, will also produce an audible signal as the ball travels over this “uneven surface” portion of the receiver or wear plate. According to the second and third embodiments of this device, referring to FIG. 4A and FIG. 7A cross-sectional view, the ball socket circumference may be manufactured at a downward sloping angle, in the proximal to distal direction. In this embodiment the highest point of the socket lip 602 FIG. 4A and 602 FIG. 7A is the proximal or leading edge of the socket 608 and the lowest point on the lip is the distal or trailing edge of the socket 608. Thus in circumstances when the ball would ordinarily overshoot the socket 608 opening , the ball hits against the rear edge 610 FIG. 7A of the socket 608. This allows the user additional insurance against damage to the tow vehicle or trailer. The ball will more easily center within the throat of the socket 608. Referring to FIG. 5, once the ball is within the socket 608, a latching device 612, as previously described, narrows the throat 606 of the socket 608 and prevents the ball from being removed.

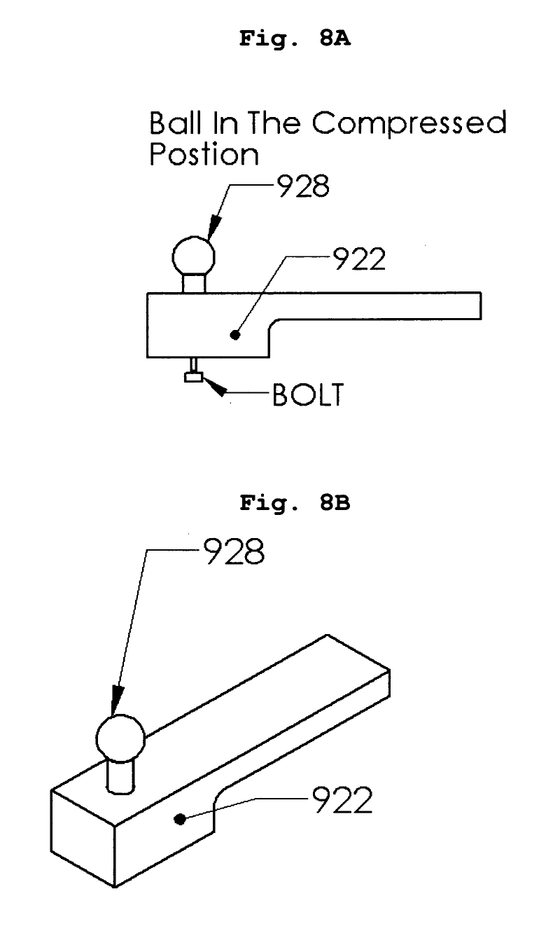

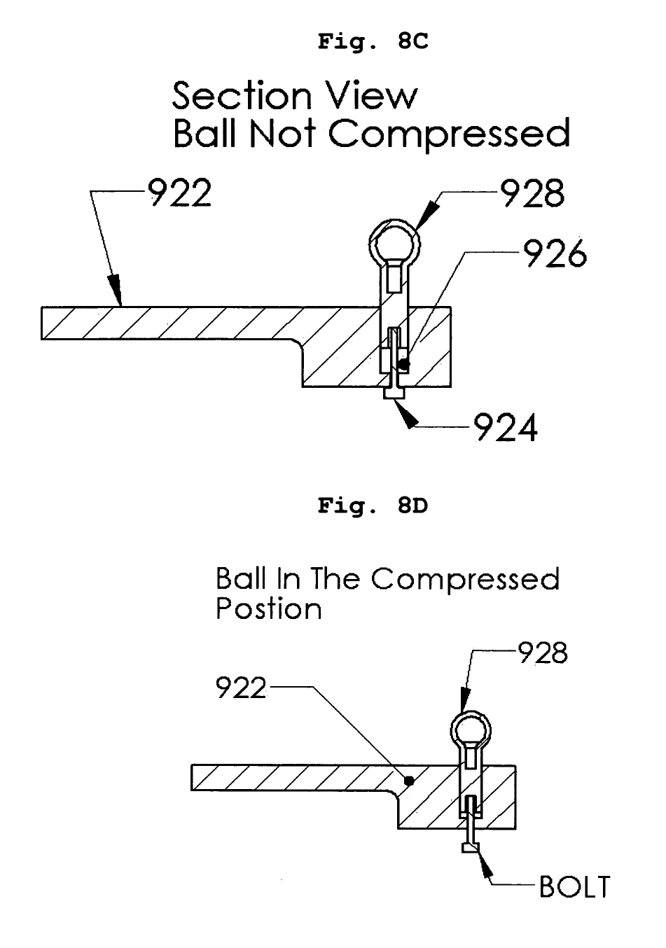

Referring to FIGS. 8A, 8B, 8C, and 8D the ball portion according to a first exemplary embodiment, the ball portion is allowed to move in a vertical direction. The ball 928 couples to a vehicle by the support member 922. The support member 922 may attach to the vehicle in a variety of manners know to one skilled in the art. When the vehicle backs up the support member 922 drives the ball 928 against the receiver plate. The ball 928 moves against the receiver plate pushing the ball portion 928 downward in a vertical direction into a recess 926 within the support member 922. Once the ball 928 is underneath the socket, a spring or other mechanical device pushes the ball 928 up into the socket. The socket may then be coupled to the ball 928 for travel. The ball portion may also have a bolt. The bolt is push down and extends outside the support member 922 when the ball is in a compressed position. The bolt may allow the user to identify when the ball is in a compressed position and aid to allow the user to push the ball into the socket.

The guide assembly 300, 700 disclosed in the first and second exemplary embodiments may be made of metal or other suitable material. The metal or suitable material may be stamped or molded into shape. The guide assembly 300, 700 may also be molded or permanently coupled to the socket portion and/or trailer frame. The guide assembly 300, 700 disclosed in the first and second exemplary embodiment may have a wear plate or other low friction surface on the underside of the receiving plate. The wear plate provides a surface for the ball portion to slide against as the receiving plate rides over the ball portion. The wear plate may be a rigid plastic or other low friction material. The wear plate may be coupled to the receiving plate with a variety of fasteners. The fasteners may be permanent or removable to allow replacement of the wear plate after continued use. Alternatively, the receiver plate ball contact surface and the inner surfaces of the two side plates may have an applied coating to obtain wear resistance and to lower the coefficient of friction. Similarly, the hitch ball socket may have a friction reducing coating applied to its inner surface. The inner surface of the hitch socket coating may also serve to cushion the engagement process when the socket drops down over the hitch ball.

In certain instances it may be desirable to avoid lifting the tow vehicle vertically while aligning transversely during the coupling process. In one embodiment, the tow vehicle is equipped with a hitch ball support that can be compressed to travel downwards in a vertical track as it is pushed against the reverse incline of the receiver plate. The ball compresses downward against the resistance of a spring, rubber compression device, pneumatic or other upward force, as it travels down the receiver plate towards the hitch socket. Once the hitch ball is located beneath the socket, the upwards spring, compressed rubber, pneumatic or other force will drive the hitch ball upwards, fully engaging it into the hitch socket. The ball is either passively latched upon seating or manually latched to secure it within the socket.

Modifications and substitutions by one of ordinary skill in the art are considered to be within the scope of the present invention, which is not to be limited except by the following claims.

The invention claimed is:

1. A trailer hitch comprising:
two support members extending substantially beyond a socket portion;
a receiving plate with a distal end coupled to the socket portion and the receiving plate extending to a proximal end from the socket at an incline wherein the proximal end is wider than the distal end portion;
two side plates extending at a downward angle from each side edge of the receiving plate between the proximal end and proximal end.

2. The trailer hitch of claim 1, wherein the proximal end of the receiving plate has a rounded profile.

3. The trailer hitch of claim 1, wherein the two side plates extending at a downward angle from each side edge of the receiving plate between the proximal end and distal end and have a bottom edge substantially parallel to the angle of the receiver plate.

4. The trailer hitch of claim 3, wherein the two side plates do not interfere with any portion of a hitch ball assembly.

5. The trailer hitch of claim 1, wherein a bottom surface of the receiver plate and the inside surface of the two side plates are coated with a friction reducing coating.

6. The trailer hitch of claim 1, wherein the two side plates extending at a downward angle from each side edge of the receiving plate between the proximal end and distal end and have a bottom edge substantially parallel to a level ground.

7. The trailer hitch of claim 6, wherein the two side plates interfere with a portion of a hitch ball assembly.

8. The trailer hitch of claim 1, wherein the bottom surface of the receiver plate includes on or more bumps located at the distal portion of the plate in a radial direction in proximity to the socket.

9. The trailer hitch of claim 1, wherein the bottom surface of the receiver plate includes a groove located at the distal portion of the plate in a radial direction in proximity to the socket.

10. The trailer hitch of claim 1, wherein the bottom surface of the receiver plate includes a series of grooves located at the distal portion of the plate in a radial direction in proximity to the socket.

11. The trailer hitch of claim 1, wherein the receiving plate can support the tongue weight of the trailer.

12. The trailer hitch of claim 1, wherein the two support members have a “U” shaped profile with the opening of the “U” facing inward.

13. The trailer hitch of claim 1, wherein the two support members each have multiple fasteners located along the length of the support member coupling the support member to the trailer.

14. A trailer hitch comprising:
a receiving plate with a distal end that is integral to a socket and a frame portion of a trailer wherein the receiving plate extends to a proximal end from the socket at an incline and the proximal end is wider than the distal end portion and has a rounded profile and the receiver plate supports the tongue weight of the trailer;
two side plates extending at a downward angle from each side edge of the receiving plate between the distal end and proximal end; and
an angled socket opening wherein a proximal lip of the socket opening is higher than a distal lip of the socket opening.

15. The trailer hitch of claim 14, wherein the two side plates extending at a downward angle from each side edge of the receiving plate between the proximal end and distal end and have a bottom edge substantially parallel to the angle of the receiver plate.

16. The trailer hitch of claim 14, wherein the two side plates extending at a downward angle from each side edge of the receiving plate between the proximal end and distal end and have a bottom edge substantially parallel to a level ground.

17. The trailer hitch of claim 16, wherein the two side plates interfere with a portion of a hitch ball assembly limiting the turning angle of the trailer.

18. The trailer hitch of claim 14 wherein a bottom surface of the receiver plate has a removable wear plate coupled to the bottom surface.

19. The trailer hitch of claim 14, wherein a trailer jack has a referencing system for repeatable jacking height.

20. A method for hitching a trailer to a vehicle comprising the following acts:
pushing a ball portion in a horizontal direction against a receiving plate wherein pushing the ball portion in a horizontal direction further causes a socket portion to move upward in a vertical direction;
pushing a ball portion in a horizontal direction against the receiving plate wherein pushing the ball portion in a horizontal direction causes the tongue weight of the trailer to be transferred from a support point onto the receiver plate;
pushing a ball portion in a horizontal direction against a side plate wherein pushing the ball portion in a horizontal direction further causes a socket portion to also move in a horizontal direction;
pushing a ball portion against a series of bumps located in proximity to a socket causes a mechanical vibration alerting the operator of potential engagement with the socket; and
pushing a ball portion past a lower front lip of the hitch socket and allowing the ball portion to hit a higher rear lip of the socket avoiding overshooting the socket by the ball portion.
